(19) United States
(12) Patent Application Publication
(10) Pub. No.: US 2012/0204205 A1
(43) Pub. Date: Aug. 9, 2012

(54) Method And Device For Creating A Broadcasting Program For A Display Device

(75) Inventors: Florian KNOEBL, Munich (DE); Ingolf VON WITTKEN, Munich (DE)

(73) Assignee: Media-Saturn-Holding GmbH, Ingolstadt (DE)

(21) Appl. No.: 13/364,709

(22) Filed: Feb. 2, 2012

(30) Foreign Application Priority Data
Feb. 3, 2011 (DE) 10 2011 000 483.1

(51) Int. Cl. H04N 21/25

(52) U.S. Cl. 725/25

(57) ABSTRACT

A method for creating a broadcasting program for a display device, such as a television screen, wherein the broadcasting program comprises at least one broadcasting loop, in which a plurality of categories of broadcasts are defined, the categories of the broadcasts being weighted so as to assign a proportion of time within the broadcasting loop to each category, a category sequence being formed with individual sections corresponding to the categories in a predefined order, wherein sections corresponding to one or more of the same category may be contained within each category sequence while observing the proportion of time assigned to the category, different users having different access rights to different categories in the category sequence so as to include broadcasts in the sections of the category sequence corresponding to the categories in order to create the broadcasting loop.

### FIELD OF THE INVENTION

The invention relates to a method for creating a broadcasting program for a display device, such as a television screen, to a computer program for carrying out the method and to a respective system.

### BACKGROUND OF THE INVENTION

“Digital signage systems and instore TV systems” are known on the market, wherein company-specific content, advertising, entertainment, current news and the like can be broadcast selectively at a wide range of locations. At least some of the programs are generally adapted to the respective environment and target group. For example, it is known in stores to broadcast advertising for the products to be purchased there as well as information concerning these products. It is possible to change and control the broadcasting content centrally and/or decentrally. Central content management systems are often used for this purpose. It is also known to process and amend different broadcasting blocks by different users according to predefined access rights.

Examples of such systems can be found in WO 2009/073624 A2 or EP 2 000 967 A1.

An object of the invention is to provide a digital signage system or an instore TV system which allows central and decentral setting of contents in a broadcasting program. It shall be possible for different users, without greater knowledge of the underlying system, to adjust contents in the broadcasting system and, nevertheless, for the form and content of the broadcasting program to be controlled by a superior position.

### SUMMARY OF THE INVENTION

The method according to the invention is used to create a broadcasting program, also referred to hereinafter as a program in short, for a display device, such as a television screen in a digital signage system or instore TV system. With the method according to the invention, a plurality of categories of broadcasts are defined and weighted so as to assign to each category a proportion of time within a broadcasting loop of the program. A category sequence is formed from a plurality of sections corresponding to the categories, wherein the proportion of time assigned to the respective category is to be observed for each section. The sections in the category sequence are arranged in a predefined order, wherein a plurality of sections of the same category may be contained within each category sequence if the proportion of time assigned to the category is observed. In accordance with the invention, different users have different access rights to different categories in the category sequence so as to include broadcasts in the sections of the category sequence corresponding to the categories in order to create the broadcasting loops of the program.

With the method according to the invention, it is possible to create a digital signage or instore TV system in which the structure of a program and, in particular, the rules for the structure of the program are controlled centrally, wherein other specific broadcasting content and templates are predefined centrally and, nevertheless, broadcasting content can also be formed, included and/or changed locally. Owing to a hierarchical rights management, it is possible to control the broadcasts in a program centrally and, nevertheless, to shape them locally, within defined limits.

In accordance with the invention, a broadcasting program is formed of a broadcasting loop which repeats several times and for which a category sequence, that is to say a predefined sequence of time sections of specific categories is defined. Different users have different access rights to set up broadcasts (also referred to as content) in the broadcasting loop according to the category sequence. It is thus possible to provide a fixed pattern for the program and also to ensure that specific broadcasting content can be broadcast at predefined intervals, while, nevertheless, individual broadcasting content can also be included in the broadcasting loops of individual programs within limits. The invention allows a multiplicity of users having different access rights to simultaneously access a program and to set up broadcasting content in the categories for which they are authorized.

In the method according to the invention, the program is preferably formed of a plurality of broadcasting loops with the same category sequence, wherein, in at least two successive broadcasting loops, different specific broadcasts can be included in the sections corresponding to the categories. A predefined distribution of the categories for the broadcasts, for example the categories of information, entertainment, advertising, local news, is thus observed, while the sequence of the actual broadcasts remains versatile and thus of interest to a viewer.

Whereas a playlist is produced in WO 2009/073624 A2 for example, that is to say a sequence of broadcasts or content which is increased or reduced every time an item of content is added or removed, the invention provides a predefined category sequence in which a sequence of time sections corresponding to individual categories is defined so that a plurality of broadcasting loops are always created on the basis of said category sequence, wherein the sections corresponding to the categories are repeated in successive broadcasting loops at identical intervals and with identical weighting. If new broadcasting content is to be set up in the broadcasting loop, this occurs by replacing or supplementing the broadcasting content provided previously in the sections of the corresponding category and not by inserting new sections into the category sequence.

The actual broadcasts are preferably stored in a library, wherein different users have access to broadcasts of different categories according to different access rights. The library is preferably a central library which can be accessed via a server. For example, an administrator may have access to all categories and assigned broadcasts, while users who have less extensive access rights have access to increasingly fewer categories and assigned broadcasts and/or to different sub-groups of the categories.

According to the invention, broadcasts can be created using templates which are stored in the same library or in another library. To produce broadcasts from the templates, different users again preferably have access to templates of different categories according to different access rights. It is thus ensured that not everybody who would like to use the method according to the invention to create a program can access any template. Rather, it is ensured in accordance with a hierarchical rights management that each user only obtains the rights necessary for his area.

In this regard it should be noted that, in accordance with the invention, individual users generally have no influence on the definition of the categories or the shaping of the category sequence, but that in practice an interface is made available to users, via which they can access broadcasts and templates of the categories unlocked to them so as to process and set these up in the broadcasting loop according to the predefined category sequence. By contrast, the definition of the categories, creation of the category sequence, and maintenance of the library and access rights generally take place at a central, superior location.

In the preferred embodiment of the invention, the broadcasts for certain categories are also provided via this central location.

At least one category preferably concerns optional broadcasts, wherein more actual broadcasts for this category are made available to the authorized users for selection than can be included in the sections of the category sequence corresponding to the category. A user may select one or more broadcasts from the available broadcasts for this category and may arrange the category sequence in such a way that in each case the same broadcast or changing broadcasts is/are broadcast in successive broadcasting loops in a corresponding section of the category sequence. A user generally has the right, for his category, to view broadcasts and content, to delete broadcasts and content from a broadcasting loop or to include broadcasts and content in the broadcasting loop. A user's authorisation may be allocated per category and per broad-casting location, and possibly also for a plurality of categories and/or a plurality of broadcasting locations.

In the preferred embodiment of the invention, at least one further category concerns compulsory broadcasts, wherein just as many actual broadcasts are made available for this category as can be included in the sections of the category sequence corresponding to the category. This means that certain sections in the category sequence can always be filled with only one specific broadcast. This may be implemented by a user or may be provided automatically by a superior system.

According to a preferred embodiment of the invention, at least one further category also includes marketed broadcasts, such as external advertising. A maximum of as many concrete broadcasts as can be included in the sections of the category sequence corresponding to this category are made available for this category. For example, if five sections of the category “advertising” are provided in a category sequence, no more than five broadcasts may be provided for this category for a broadcasting location so as to ensure that each of these marketed broadcasts can be broadcast precisely once within a cycle of a broadcasting loop. If an insufficient number of marketed broadcasts are provided to fill the sections of the category sequence corresponding to this category, for example if less than five marketed broadcasts are provided in the aforementioned example, the corresponding sections are then filled with dummy broadcasts, for example with music videos. It is thus ensured that each marketed broadcast can be broadcast at least once, and not less, within each cycle of a broadcasting loop. A marketed broadcast is preferably broadcast precisely once, and neither less often nor more often. In addition, it can thus be ensured that no more than a predefined number of marketed broadcasts are contained in a broadcasting loop.

In accordance with the invention, the actual broadcasts can be selected from a library according to the category and inserted to the category sequence. This generally occurs by a user equipped with the corresponding access rights. An authorized user can call up a plurality of specific broadcasts from the library for a category and, when creating a plurality of successive broadcasting loops, can automatically include the specific broadcasts in the category sequence in a predefined order or randomly so as to accordingly fill the sections of the broadcasting loop corresponding to the categories. It is thus ensured that successive broadcasting loops have an interesting and varied course without the need for extensive user intervention.

In accordance with the invention, the categories and category sequence are preferably provided on a server to which a plurality of workstations have access which are connected to the display devices. Different users have access to the server to include specific broadcasts in the same category sequence and can thus generate different specific concrete programs.

The server preferably provides an interface, via which an authorized user has access to the library to call up specific broadcasts in accordance with his authorisation and to include these in the category sequence. The individual user cannot change the categories or category sequence, but can only include or change the broadcasts or broadcasting content in sections of the category sequence to which he has access. In practice, the concrete broadcasts may be loaded to the user's workstation, and the workstation plays these broadcasts according to the predefined category sequence without the need for constant contact with the server and/or library. Furthermore, the workstations may access the server at regular intervals to check whether there were any changes in the categories and/or the category sequence assigned thereto, whether new broadcasting content is available or whether specific broadcasting content has been deactivated. For this purpose, the workstation may automatically register with the server with its IP address for example, and the server can then display and/or automatically copy the broadcasts for selected categories and updated data provided for this workstation. The server may also address the registered workstations to check the program running on the workstations and/or to inform the workstations of changes in categories, category sequences and/or broadcasting content. This may occur automatically or manually at regular or irregular intervals.

In a preferred embodiment of the invention, at least one display device is connected to the workstation to broadcast a program which is adapted to the environment of the display device. For example, broadcasts can be broadcast in a store which advertise or describe goods sold in the store or provide information concerning these goods. According to the invention, a user assigned to the environment of the display device, such as a person in charge of the store, may have access rights to at least one of the categories to include corresponding broadcasts in the broadcasting loop. In addition, a superior administrator should have access rights for at least one further category.

In a specific embodiment, the program is broadcast on a display device in a store, wherein this store has a number of departments and is part of an amalgamation of stores. In this case, at least one category should be provided for department-specific content and a respective person responsible for the department should have access rights to include corresponding broadcasts in the category sequence. Furthermore, at least one category should be provided for store-specific content and a respective store manager should have access rights to include corresponding broadcasts in the category sequence. In addition, at least one category should be provided for content relating to some of the amalgamation or the entire amalgamation, and a respective regional manager or central administrator should have access rights to include corresponding broadcasts in the category sequence. Furthermore, categories may be provided for example for news, advertising and/or entertainment.

It is possible to check the specific broadcasts at a central location before their inclusion in a library and/or before their inclusion in a broadcasting loop. But this is not a necessity.

The invention also provides a broadcasting program for broadcasting on a multiplicity of display devices which was created in accordance with the above method, and a computer program for executing the described method.

Lastly, the invention provides a system for creating a program for a display device, such as a television screen, including a server, a central library which can be accessed via the server, and a control program for controlling the server to execute the described method. According to the invention, a first multiplicity of concrete broadcasts and templates for producing broadcasts is stored in the central library. The system works with a multiplicity of workstations, via which a multiplicity of users can access the server, wherein one or more display devices are connected to each workstation. A second multiplicity of specific broadcasts may be stored decentrally on the workstations.

In a specific embodiment, which the applicant has in use at the time of filing this application, the system of this invention is used to create about 3,600 different program loops for 3,600 different departments, based on a central online library and a centrally hosted system. These 3,600 different program loops are distributed among 14 countries and about 600 stores, running on about 220,00 screens. For each of the 3,600 departments, store managers as well as other persons having access rights in different hierarchical levels can access the system to include specific broadcasts. To implement this system, the invention needs neither editorial staff nor a supervisor. Nevertheless, the invention ensures, without human intervention, that all broadcasting loops observe a defined length and sequence and weighting of categories.

When creating the program, it is possible to include finished, stored broadcasts therein. In addition, at least some of the specific broadcasts can be restructured from templates and the like during the creation of the broadcasting loop itself.

### BRIEF DESCRIPTION OF THE DRAWINGS

The invention will be described in greater detail hereinafter on the basis of some embodiments and with reference to the drawings, in which:

FIG. 1 is a block diagram of a system for implementing the method according to the invention;

FIG. 2 is a flow diagram of the method according to the invention;

FIG. 3 shows an example of a category sequence which was created by the method according to the invention;

FIG. 4 shows a diagram for visualising various criteria for creating the category sequence according to the invention;

FIG. 5 shows a time sequence of a category sequence which was created by the method according to the invention;

FIG. 6 shows another diagram for visualising criteria for creating the category sequence according to the invention;

FIGS. 7 and 8 show screenshots of the input sides of an exemplary user interface;

FIG. 9 shows a screenshot of the interface for access to a library; and

FIG. 10 shows a screenshot of an exemplary representation of access rights for different users and different broadcasting categories.

### DETAILED DESCRIPTION OF EMBODIMENTS

The invention provides a method and a system for creating a program for a digital signage or a store TV device, which make it possible to centrally control and monitor the creation of the program. Categories and a category sequence for a broadcasting loop of the program and specific broadcasting content and templates for specific categories are provided by a central management. Furthermore, it is permitted for specific sections of the category sequence to be designed locally in accordance with defined rules, that is to say for local users to include broadcasting content in specific sections of the category sequence to compose the program in accordance with the needs of the broadcasting location. For this purpose, the invention utilises a hierarchical rights management and a classification of the content of the program in accordance with categories, and distinguishes between categories and specific concrete broadcasts or broadcasting content. Access rights to specific broadcasts and templates can be assigned in accordance with different criteria. For example, a user may have access to one or more categories of the category sequence for one or more broadcasting locations. These access rights are allocated for example according to the position of the user in an amalgamation of stores or other broadcasting locations, according to geographical assignment, according to the role of the user in the amalgamation, etc. In addition, administrators can manage the entire system in different hierarchical levels, for a plurality of users, geographical regions, etc.

A plurality of users with different access rights can access a program at the same time via a plurality of workstations and can fill the categories accessible to the respective user with broadcasting content. A content management system is thus created, in which different users can design programs at international, national, regional and local level without the individual participants having to communicate. By introducing the categories and category sequence which are provided for each broadcasting loop of a program, it is ensured that each broadcasting program has a uniform structure, although numerous users can exert influence. According to the invention, specific categories may contain broadcasts which are to be booked or marketed broadcasts. By fixing a maximum number of marketed broadcasts which may be provided for such a category, it can be ensured that the respective categories are not overbooked and that said booked broadcasts are not unintentionally deleted or shifted. More broadcasts than can be broadcast in the corresponding sections of a category sequence may be provided for other categories. Owing to an automatic or manual selection among the broadcasts, a varied overall program can be generated in which the different broadcasts within the categories are automatically or manually rearranged in an alternating manner.

A category sequence is preferably defined based on an average lingering time of a viewer of the program so that each viewer sees at least one defined section of a predefined category in the category sequence within the average lingering time. In accordance with the invention, each category sequence may include categories for marketed and non-marketed broadcasting content. For the marketed content a predefined number of marketed broadcasts can be broadcast within each category sequence; corresponding sections of the category sequence are provided for this. If there are no marketed broadcasts to fill all respective sections in the category sequence, dummy broadcasts, for example music videos, may be included in the broadcast of the program.

The non-marketed broadcasts can also be split again into those which will certainly be broadcast within each category sequence and those which may, but do not have to be broadcast in the successive category sequences.

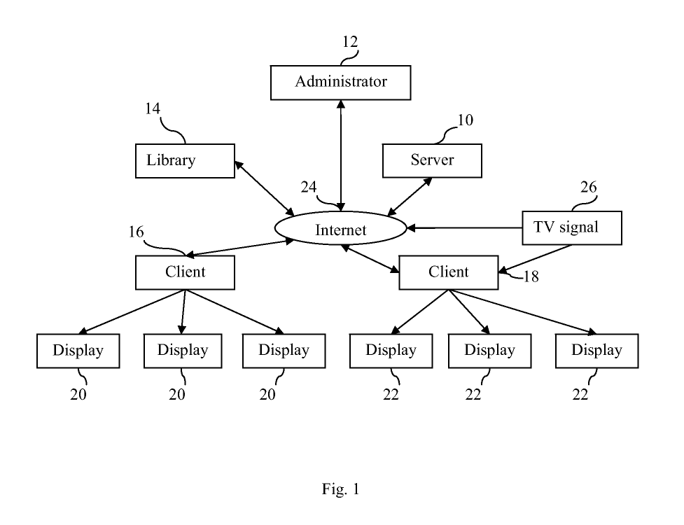

The method according to the invention can be implemented in a network-based environment, which is shown by way of example in FIG. 1. FIG. 1 shows a block diagram of an embodiment of a system for carrying out the method according to the invention. The system comprises a server 10, a central management station (administrator) 12, a digital library 14 which may be provided as part of the server 10 or separately therefrom, and a plurality of workstations 16, 18 which are assigned to different users or clients. A plurality of display devices 20, 22 are preferably coupled to each workstation 16, 18. The described components are connected via a network, such as the Internet 24. In addition, further signal sources, such as a TV transmitter 26, may be connected to the workstations 18, either directly or via the network 24. The administrator and the server may also access the additional information sources, such as the TV transmitter 26, either directly or via the network. Further possible information sources, which may be included in the method according to the invention, are DVD players, Blu-ray players and other playback devices, which for example can be connected via a high definition multimedia interface (HDMI). Instead of the Internet, the devices shown may also be connected via a LAN, WAN, Intranet, Ethernet or other suitable network. The workstations 16, 18 may be designed to broadcast the same broadcasting loop to a plurality of display devices 20, or different broadcasting loops to different display devices or groups of display devices. They may be implemented by commercially available computers, which receive input signals via their interfaces, such as a keyboard, USB port, serial port, etc. and communicate with the other devices in the system via the network.

The display devices 20, 22 may include computer monitors, televisions, screens of any type, projectors and the like. “Passive” displays are generally used, which merely receive programs to be broadcast by the workstation 16 or 18. However, it is also possible to provide interactive display devices, for example touchscreens, which allow an input by the viewer.

The group of display devices 20, 22 assigned to a workstation 16, 18 is generally provided in a sub-group of an amalgamation, for example in a department of a store, which may in turn be part of a regional, national or international store amalgamation. Other groups of broadcasting locations, for example in public areas such as underground train stations, are also within the scope of the invention. While it is possible to create a category sequence for only a single broadcasting location, the specific advantages of the invention become apparent in cases in which the same category sequence is used for a multiplicity of broadcasting locations. The invention makes it possible to individually design programs which are adapted individually to different broadcasting locations, or parts of overall programs based on the same category sequence.

It is stressed that that the system architecture shown in FIG. 1 is merely an example and can be modified in many ways.

The method according to the invention is essentially run on the server 10. This comprises a program for managing and assigning access rights and can provide a user interface for creating the broadcasting loop. It may also manage the digital library 14 and control the access to the library according to the access rights. A template manager may run on the server and manages both the creation of templates and the access thereto, as is described further below.

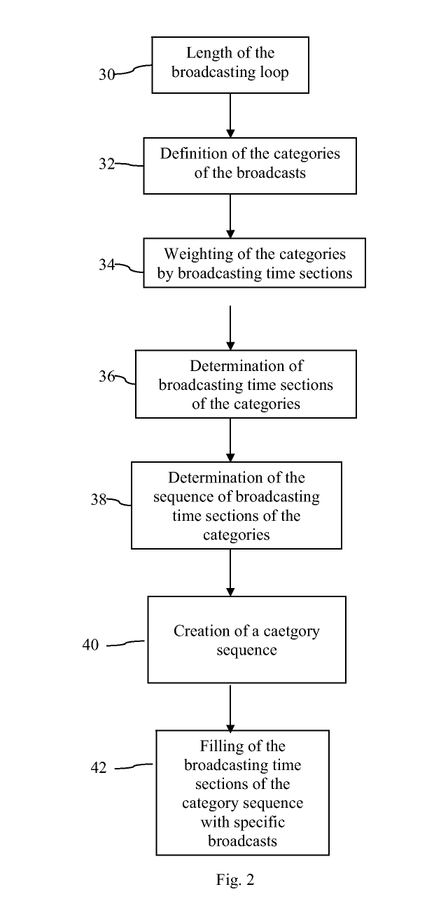

FIG. 2 shows a flow diagram of an embodiment of the method according to the invention. The method for creating a broadcast for a digital signage system starts with the fixing of the length of the broadcasting loop in step 30. An exemplary broadcasting loop may be of any selectable length. The length of the broadcasting loop is preferably adapted to the expected maximum lingering time of the viewer of one of the display devices.

In a next step 32, different categories of the broadcasts to be set up are defined and are dependent of the purpose which is to be obtained by the broadcasting loop. Examples of categories are information, entertainment, internal advertising and external advertising.

In a next step 34, the different categories are weighted to establish proportions of time to be allocated to them. Depending on the location of the display devices, different categories may be selected and different weightings conducted. For example, if the display devices are located in a consumer electronics department of a store in which televisions, DVD players and the like are offered, the entertainment category proportion will thus have the highest weighting, whereas the information and advertising categories for example can be distributed approximately equally. By contrast, if the display device is located in the point of sale area of a store, the information category may have the highest proportion, followed for example by entertainment and advertising in equal measure.

In the next method step 36, broadcasting time sections or slots are assigned to the categories depending on their weighting, wherein each category may appear a number of times within a broadcasting loop. The broadcasting time section may thus be divided into a number of subsections and distributed over the broadcasting loop. The individual broadcasting time sections should not be shorter than at least five to seven seconds, these typically being divided into broadcasting time sections of 20 seconds to a few minutes for example, depending on the type of category.

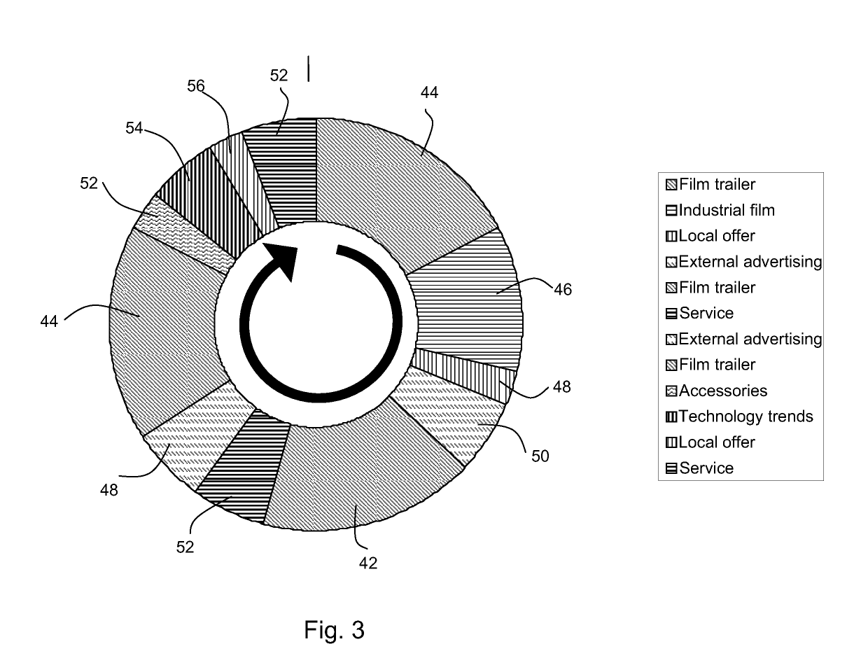

In a next step 38, the order of the individual broadcasting time sections of the respective categories is fixed and a defined category sequence is thus created. The broadcasting loop is thus fixed in terms of structure at a level of the broadcasting categories, but is not yet filled with specific content. At this point, there is thus still no specific playlist. An example of such a category sequence is shown in FIG. 3. It contains a sequence of different broadcasting categories 44 to 56, such as film trailers, industrial films, local offers, external advertising, service displays, information on accessories, and information on technology and trends, wherein some of the categories appear a number of times in the category sequence and indeed also in different broadcasting time sections. When creating such a category sequence, care should be taken to ensure that broadcasts of the same category are not next to one another and that a varied sequence of categories is provided.

Lastly, in a last step 42, the individual broadcasting time sections are filled with specific or concrete broadcasts. This step occurs in accordance with a predefined rights management for the access to templates and broadcasts, the creation of broadcasts and the setting up of these in the broadcasting loop.

The method according to the invention is explained further with reference to the example of a store amalgamation, which includes a number of stores which are each divided into a number of departments. This may also be described abstractly within the context of a horizontal and vertical division of the broadcasting locations. Each store is part of a regional amalgamation, which in turn may be part of a superior national and/or international amalgamation. Different departments of a store may be divided for example into brown goods, in particular consumer electronics devices, white goods, in particular domestic appliances, entertainment, such as audio and video media, point of sale area and services. In this example, the individual stores are divided into departments corresponding to different broadcasting locations with different category sequences. Any other type and division is possible. The individual stores may be amalgamated internationally, nationally and/or regionally, for example in accordance with German-speaking countries, federal states or other regions. The invention is also applicable to any other combination of different broadcasting locations at which different category sequences are used to create different programs.

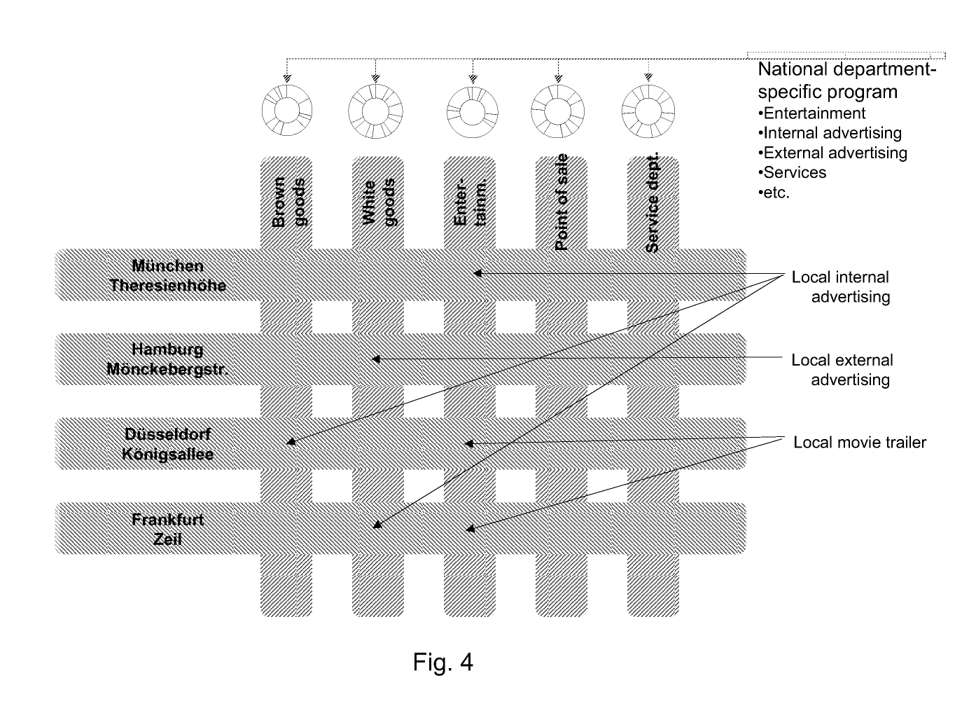

In accordance with the invention, an internal category sequence may be formed for each department of a store for example so as to create a department-specific category sequence which can be used similarly in a number of stores of an amalgamation, for example within a Federal state or a country. The rights for the setting up of specific broadcasts in the different time sections of the category sequence may be allocated differently depending on the respective department for which the category sequence is determined, and possibly also depending on a specific store or a specific region. An example of category sequences which are formed with differently weighted broadcasting categories is shown in abstract form in FIG. 4. It can be seen from FIG. 4 that five different category sequences are provided for different departments of stores and, for example, include the broadcasting categories of entertainment, internal advertising, external advertising, services, etc. The same category sequences are used at different locations. Depending on the department and store, different users, for example the department manager, have local rights for the setting up of broadcasts for selected categories, for example external advertising and/or internal advertising, whereas other content of the categories of the category sequence may be provided centrally. In this case, too, the illustration of FIG. 4 is merely an example, Of course, the category sequence may include categories other than those shown, and it may be possible for local users to set up specific broadcasts in categories other than those shown.

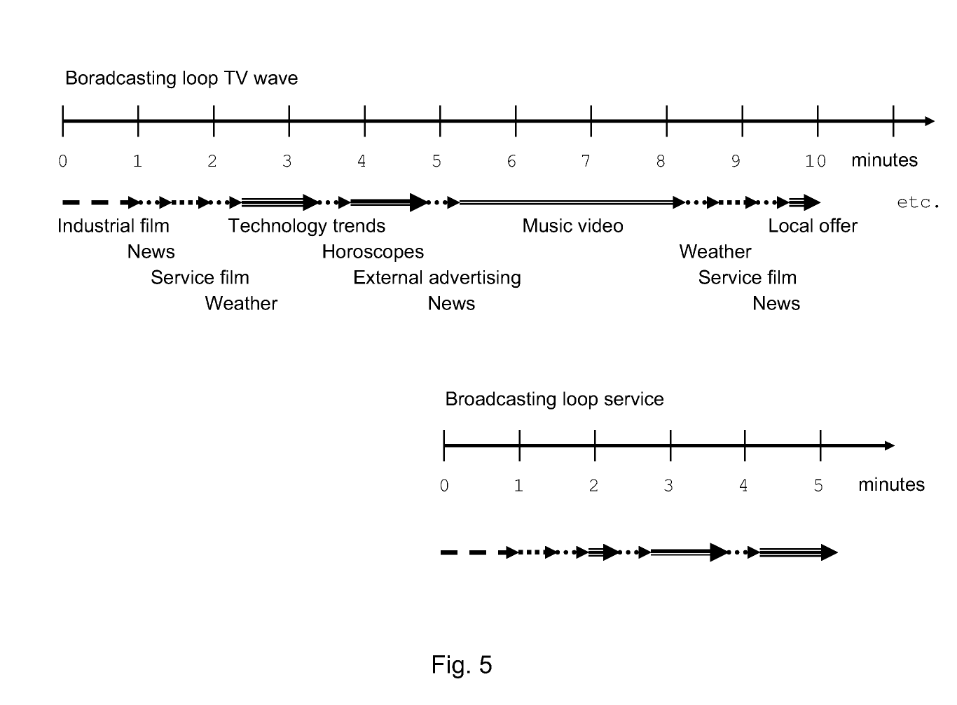

An example of the specific course of a category sequence is shown in FIG. 5. This category sequence includes the categories of industrial films, news, service films, weather, technology trends, horoscopes, external advertising, music videos, service films and local offers. The categories of news and weather appear repeatedly. The total length of category sequence is ten minutes, and the length of the individual time sections is between approximately 20 seconds and three minutes. This category sequence is used for example in a department for televisions.

In another department, such as the service area in which a shorter lingering time of the customers is normally to be expected, a category sequence may be formed with fewer parts, for example with the sequence of industrial films, service films, weather, local offers, horoscopes, external advertising, news and technology trends, as also shown in FIG. 5.

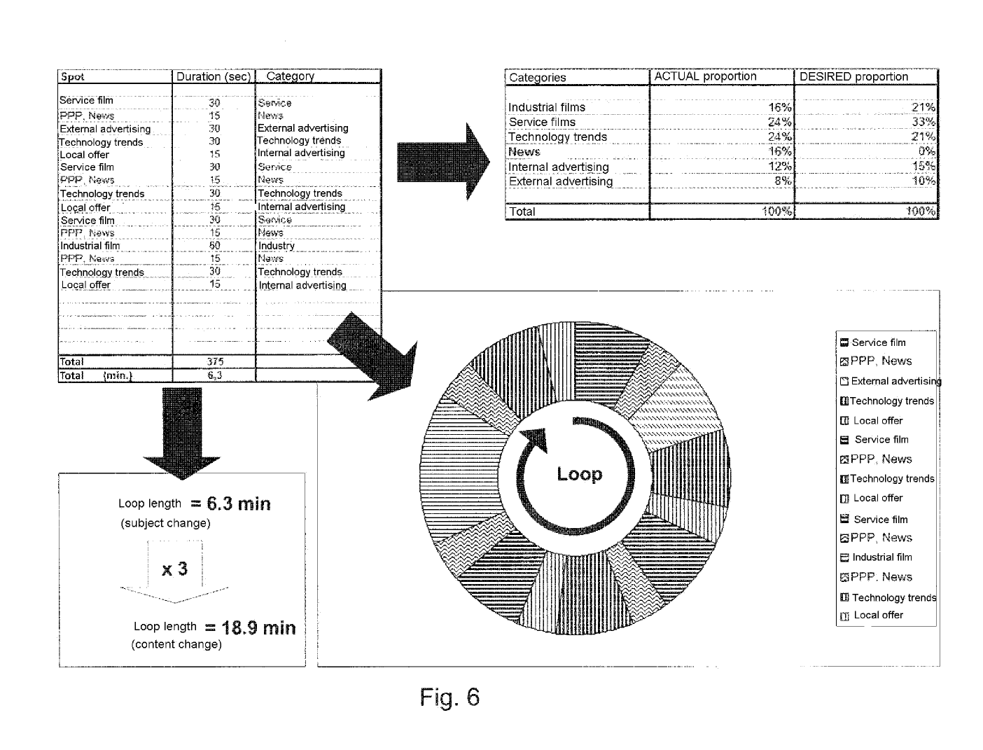

FIG. 6 shows a further example of the structure of a category sequence with different broadcasting categories. The weighting (in %) of the different categories is illustrated in the top right-hand corner of the drawing and is used as a basis for the calculation of the broadcasting time proportions of the respective categories. The sequence of the broadcasting categories with associated broadcasting time proportions, as shown in the top left-hand corner of the figure, can be established therefrom. In accordance with the invention, a category sequence may be filled with different specific broadcasts in successive cycles of the broadcasting loop, wherein the specific broadcasts can be repeated after a predefined number of cycles, for example after three cycles of the broadcasting loop.

In accordance with the invention, the specific broadcasts can be created and set up by different users in accordance with a rights management. Whereas it may be provided, for example for a specific amalgamation of stores, for specific broadcasting categories such as service films, news, technology trends and industrial films to be provided centrally, as in the specific example shown in FIG. 6, the other broadcasting categories, such as external advertising and news, can be selected decentrally. The right to set-up broadcasts of these categories may lie, for example, at the level of a department, a store or else a sub-group of the stores from the amalgamation. The right to set up specific broadcasts lies, for example, at department level or store manager level for at least one broadcasting category, such as local offers.

The specific broadcasts may be selected from the digital library or created on the basis of templates stored in the library. A user may select and store on his local workstation more broadcasts for the category to which he has access than can be set up in a category sequence. The specific broadcasts may then be selected, for example randomly or in a predefined order, and set up in the category sequence. Different specific broadcasts of the same category may be broadcast regularly in successive broadcasting loops.

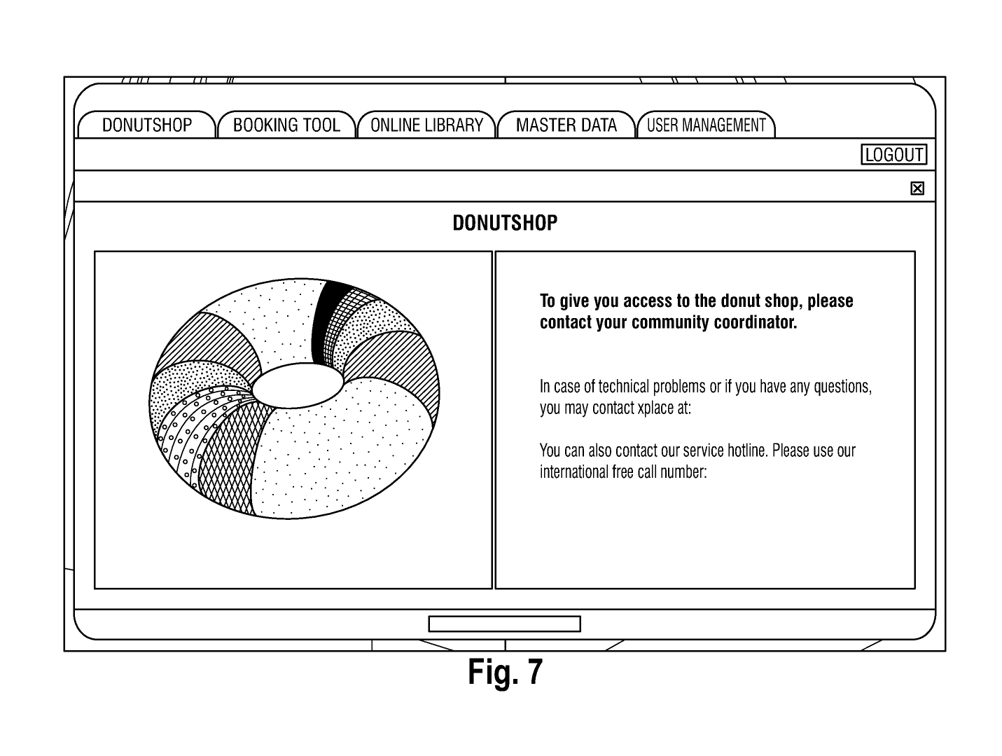

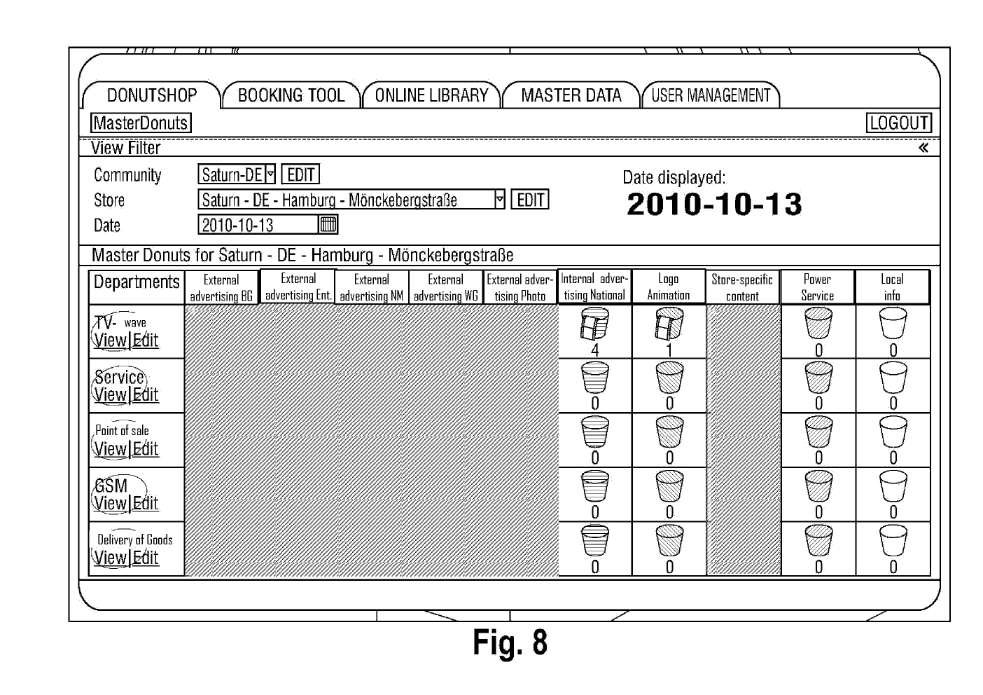

FIGS. 7 and 8 show the input sides of an exemplary user interface, wherein FIG. 7 depicts an example of the structure of a category sequence. FIG. 8 shows an example of an input screen for the creation and selection of broadcasts for shaping a specific broadcasting loop. In the example shown, the grey fields represent parts of the category sequence on which a local user has no influence, such as the broadcasting categories of “external advertising brown goods (BG)”, “external advertising entertainment (Ent)”, “external advertising new media (NM)”, “external advertising white goods (WG)” and “external advertising photo” and store-specific content, whereas a local user can access the white fields for the broadcasting categories of “internal advertising national”, “logo animation”, “Power service” and “local info” and can set up content in these categories. The different departments of a store are indicated on the left in FIG. 8, such as television department, service department, point of sale, mobile communications (GSM) and delivery of goods. In principle, the rights to set up broadcasts in different broadcasting categories may be different, for example for different departments of different stores.

In accordance with the invention, a user may book specific category sequences for his broadcasting location for specific periods, or specific category sequences may be predefined for a predefined time by a superior authority, such as a store manager, regional manager, etc. for a plurality of broadcasting locations, for example departments and/or stores.

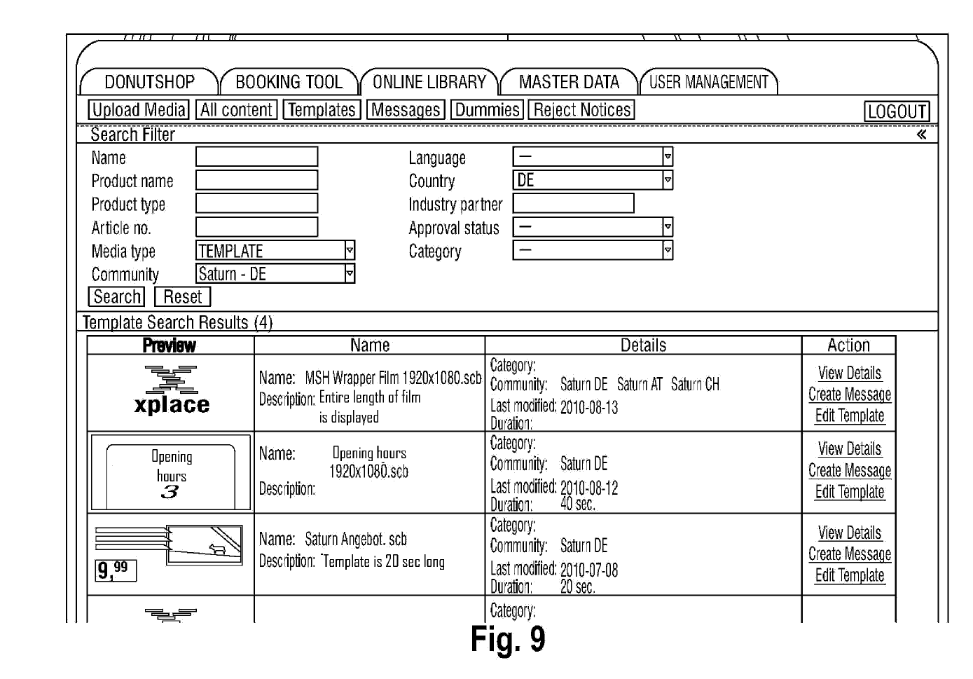

To create and set up the specific broadcasts, the method and system according to the invention access a library, as explained above. This is also referred to as an online library. A screenshot of the interface for accessing this library is shown in FIG. 9. It can be seen that the library contains a plurality of templates, such as film trailers or specific templates, for example for advertising or opening times, which are yet to be filled with specific content. FIG. 9 also shows that specific templates are only provided to specific user groups, for example specific store amalgamations in individual countries or regions. Only users having the corresponding authority hence have access to these templates.

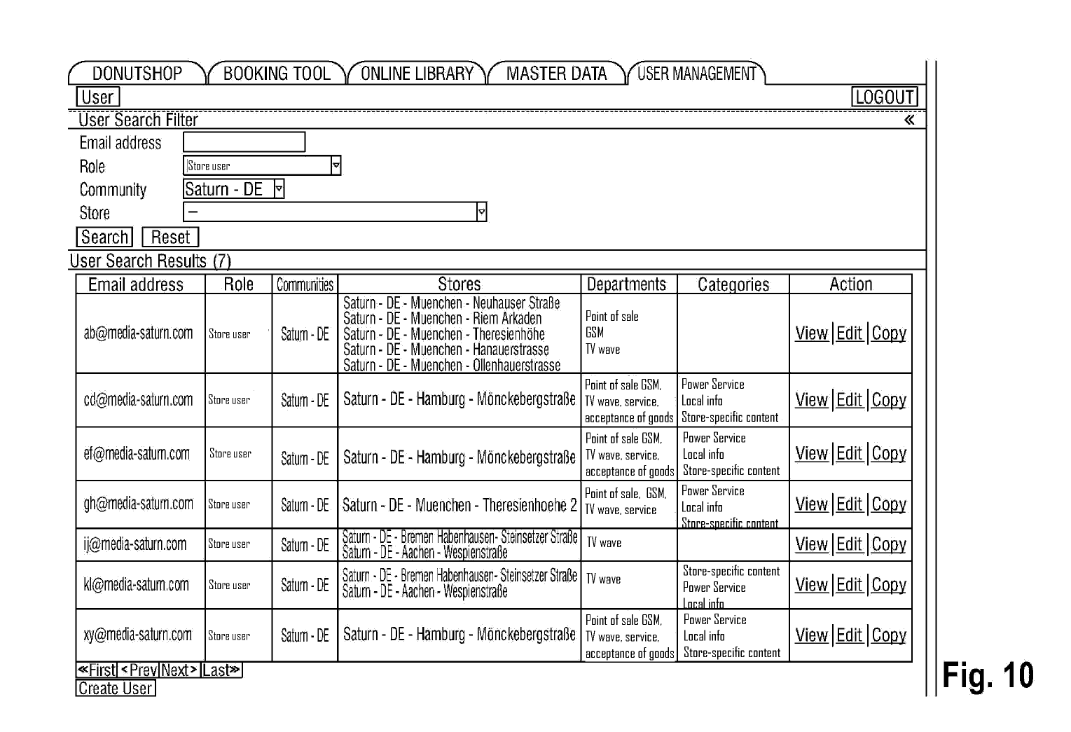

FIG. 10 shows an example as to how the access rights for different users and different broadcasting categories can be allocated. If a user wishes to create specific broadcasts according to his access rights and set these up in a category sequence, he can thus access the templates in the library and either use these as they stand, or optionally supplement them by adding local information, for example with regard to price, sales campaigns, opening times, etc., so as to set them up in the category sequence.

1. A method for creating a broadcasting program for a display device, such as a television screen, wherein the broadcasting program comprises at least one broadcasting loop, the method comprising the steps of:
defining a plurality of categories of broadcasts,
weighting the categories of the broadcasts so as to assign to each category a proportion of time within the broadcasting loop,
forming a category sequence including individual sections corresponding to the categories in a predefined order, wherein one or more of sections corresponding to the same category may be included within each category sequence while observing the proportion of time assigned to the category,
including broadcasts in the sections of the category sequence corresponding to the categories in order to create the broadcasting loop, wherein different users have different access rights to different categories in the category sequence so as to include said broadcast.

2. The method according to claim 1, wherein the broadcasting program is formed of a plurality of broadcasting loops having the same category sequence, wherein the sections corresponding to the categories are repeated in successive broadcasting loops at identical intervals and with identical weighting.

3. The method according to claim 1, wherein identical or different specific broadcasts are set up in the sections corresponding to the categories in at least two successive broadcasting loops.

4. The method according to claim 3, wherein the broadcasts provided previously in the sections of the corresponding category are replaced or supplemented when setting up new broadcasts in the broadcasting loop, without adding new sections to the category sequence.

5. The method according to claim 1, wherein the specific broadcasts are stored in a library, wherein different users have access to broadcasts of different categories according to different access rights.

6. The method according to claim 1, wherein different users create specific broadcasts by using templates which are stored in a library, wherein different users have access to templates of different categories according to different access rights.

7. The method according to claim 1, wherein at least one category concerns optional broadcasts and, for this category, more specific broadcasts are made available to the authorized users for selection than can be included in the sections of the category sequence corresponding to the category.

8. The method according to claim 1, wherein at least one category concerns compulsory broadcasts and, for this category, just as many specific broadcasts are made available to the authorized users as can be included in the sections of the category sequence corresponding to the category.

9. The method according to claim 1, wherein at least one category concerns marketed broadcasts and, for this category, a maximum of as many specific broadcasts as can be included in the sections of the category sequence corresponding to the category are made available to the authorized users.

10. The method according to claim 9, wherein, if an insufficient number of marketed broadcasts are provided to fill the sections of the category sequence corresponding to the category, these sections are filled with dummy broadcasts.

11. The method according to claim 1, wherein specific broadcasts are selected from a library according to the categories and are added to the category sequence.

12. The method according to claim 11, wherein an authorized user for at least one category calls up a plurality of specific broadcasts from the library and, when creating a plurality of successive broadcasting loops, the specific broadcasts are automatically included in the category sequence in a predefined order or randomly so as to fill the sections of the broadcasting loop corresponding to the category.

13. The method according to claim 1, wherein the categories and the category sequence are created on a server, to which a workstation assigned to the display device has access.

14. The method according to claim 13, wherein the server provides an interface, via which an authorized user has access to a library so as to call up specific broadcasts according to his authorization and include these in the category sequence.

15. The method according to claim 13, wherein different users have access to different categories of the category sequence on the server.

16. The method according to claim 13, wherein at least one display device is connected to the workstation to broadcast a broadcasting program which is adapted to the environment of the display device, wherein a user assigned to the environment of the display device has access rights to at least one of the categories so as to include corresponding broadcasts in the category sequence, and wherein a superior administrator has access rights to at least one further category so as to include corresponding broadcasts in the category sequence.

17. The method according to claim 1, wherein the same category sequence is provided by an administrator for a multiplicity of users and display devices.

18. The method according to claim 1, wherein the broadcasting program is broadcast on a display device in a store, wherein the store comprises a plurality of departments and is part of an amalgamation of a plurality of stores, wherein
at least one category is provided for at least one of:
department-specific content, wherein
a respective person in charge of the store has access rights to include corresponding broadcasts in the category sequence;
store-specific content, wherein a respective store manager has access rights to include corresponding broadcasts in the category sequence;
content relating to part of the amalgamation or the entire amalgamation, wherein a respective administrator has access rights to include corresponding broadcasts in the category sequence;
news;
advertising; and
entertainment.

19. A broadcasting program to be broadcast on a multiplicity of display devices, the broadcasting program comprising at least one broadcasting loop, in which
a plurality of categories of broadcasts are defined,
the categories of the broadcasts are weighted so as to assign to each category a proportion of time within the broadcasting loop,
a category sequence is formed with individual sections corresponding to the categories in a predefined order, wherein one or more of sections corresponding to the same category may be contained within each category sequence while observing the proportion of time assigned to the category,
wherein broadcasts are included, by different users have different access rights to different categories in the category sequence, in the sections of the category sequence corresponding to the categories in order to create the concrete broadcasting loop.

20. A computer program for executing, when run on a data processing machine, a method for creating a broadcasting program for a display device, wherein the broadcasting program comprises at least one broadcasting loop, wherein the computer program comprises program means for
defining a plurality of categories of broadcasts,
weighting the categories of the broadcasts so as to assign to each category a proportion of time within the broadcasting loop,
forming a category sequence with individual sections corresponding to the categories in a predefined order, wherein one or more of sections corresponding to the same category may be contained within each category sequence while observing the proportion of time assigned to the category,
receiving broadcasts from different users wherein the different users have different access rights to different categories in the category sequence so as to include broadcasts in the sections of the category sequence corresponding to the categories in order to create the broadcasting loop.

21. A system for creating a broadcasting program for a display device, such as a television screen, the system including a server, a central library which can be accessed via the server, and a control program for controlling the server to execute a method for creating said broadcasting program, wherein the control program comprises program means for defining a plurality of categories of broadcasts,
weighting the categories of the broadcasts so as to assign to each category a proportion of time within the broadcasting loop,
forming a category sequence with individual sections corresponding to the categories in a predefined order, wherein one or more of sections corresponding to the same category may be contained within each category sequence while observing the proportion of time assigned to the category,
receiving broadcasts from different users wherein the different users have different access rights to different categories in the category sequence so as to include broadcasts in the sections of the category sequence corresponding to the categories in order to create the broadcasting loop,
wherein specific broadcasts and templates for creating broadcasts are stored in the central library.

22. The system according to claim 21, comprising a multiplicity of workstations via which a multiplicity of users can access the server, wherein one or more display devices are connected to each workstation.

23. The system according to claim 22, wherein the workstations are designed to call up specific broadcasts and templates for creating broadcasts from the library via the server and to store them in the workstations.
